(19) United States
(12) Patent Application Publication
(10) Pub. No.: US 2013/0152182 A1
(43) Pub. Date: Jun. 13, 2013

(54) SYSTEM AND METHOD FOR ENABLING, VERIFICATION OF ONE OR MORE CREDENTIALS OF ENTITIES AND SHARING RESULT OF VERIFICATION

(71) Applicant: Serhat PALA, (US)

(72) Inventor: Serhat PALA, (US)

(21) Appl. No.: 13/323,857

(22) Filed: Dec. 13, 2011

(51) Int. Cl. G06F 21/20

(52) U.S. Cl. 726/7

(57) ABSTRACT

A system and method for enabling, verification of one or more credentials of entities and sharing result of verification is provided. The system is configured to receive request from an entity to verify a credential, verify the credential of the entity according to a predefined methodology and allow the entity to share at least a part of result of verification.

### BACKGROUND

1. Field

The disclosed subject matter relates generally to the field of improving, trust corresponding to or marketability of, entities among their present or prospective associates and, more particularly but not exclusively, to facilitate, verification of claims made by entities and sharing result of verification to enhance, trust corresponding to or marketability of, entities among their present or prospective associates.

2. Discussion of Related Field

It is a well know fact that, with the ever increasing growth and adoption of the internet, entities, such as, individuals have started interacting and engaging with others whom they may not have met and are not familiar about their credentials. For example, users have started using online dating websites to find their partners. Similarly, online job sites are used by employers and job seekers. Further, online social networking platforms are used to make new acquaintance. Additionally, online medium is used to interact with people who are not known personally to explore working together on projects, sharing apartment and ride, among others. Increased interaction with people who are not known personally and the requirement to explore association with them, has brought about the need for a technique to verify credentials of individuals.

While the need for verification of credentials of people who are not known personally to explore association is evident, verification of credentials of people who are known is also required in various scenarios. For example, a person sponsoring a student's education might want the student to refrain from drug abuse. Similarly, a divorced couple might require each other to refrain from drug abuse and not indulge in criminal activity, to keep seeing their kids.

Similar to individuals, business entities also have the need to have their credentials verified. Such verification of their credentials and sharing of verified credentials might help them in attracting business from prospective clients, investors and employees.

In light of the foregoing discussion, there is a need to facilitate, verification of claims made by entities and sharing result of verification to enhance, trust corresponding to or marketability of, entities among their present or prospective associates.

### SUMMARY

Summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In accordance with one embodiment, a system for enabling, verification of one or more credentials of entities and sharing result of verification is provided. The system is configured to receive request from an entity to verify a credential, verify the credential of the entity according to a predefined methodology and allow the entity to share at least a part of result of verification.

In accordance with another embodiment, a method for enabling, verification of one or more credentials of entities and sharing result of verification is provided. The method includes, receiving request from an entity to verify a credential, verifying the credential of the entity according to a predefined methodology, and allowing the entity to share at least a part of result of verification.

These and other advantages of the present invention will be clarified in the description of the embodiments taken together with the attached drawings in which like reference numerals represent like elements throughout.

### BRIEF DESCRIPTION OF DRAWINGS

Embodiments are illustrated by way of example and not limitation in the Figures of the accompanying drawings, in which like references indicate similar elements and in which:

FIG. 1 illustrates a system 100 configured to facilitate, verification of credentials of individuals and sharing result of verification, in accordance with an embodiment;

FIG. 2 is a flow chart illustrating a method of receiving request from an individual to verify his credentials, in accordance with an embodiment;

FIG. 3 illustrates a user interface, in which the individual defines statements, which he wishes to be verified, in accordance with an embodiment;

FIG. 4 illustrates a user interface, which provides the individual with verification options, in accordance with an embodiment;

FIG. 5 illustrates a user interface, wherein the registered user initiates generation of access code, in accordance with an embodiment; and

FIG. 6 illustrates an online profile of a registered user, in accordance with an embodiment.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

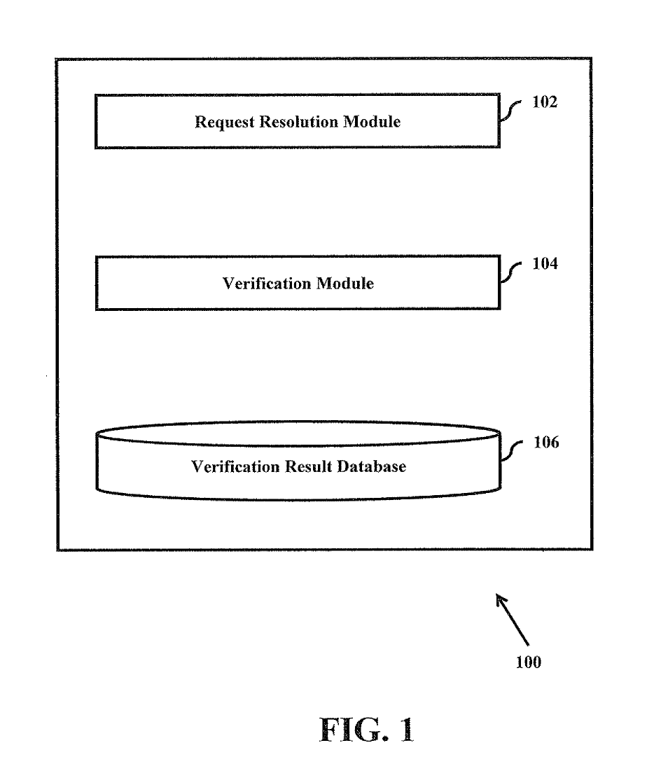

Referring to FIG. 1, wherein FIG. 1 illustrates a system 100 configured to facilitate, verification of credentials of entities and sharing result of verification, in accordance with an embodiment. System 100 includes a request resolution module 102, a verification module 104 and a verification result database 106. It may be noted that entities can be, for example, individuals or business entities, educational institutions and hospitals, among others.

Request resolution module 102 is configured to receive and address requests from entities to verify their credentials. The requests may be sent by entities through a user interface, such as a website. The requests may also be sent by entities through wireless communication devices, such as, mobile phone. The request resolution module 102 can also be configured to receive and address requests to access verified credentials of entities. Further, request resolution module 102 can be configured to receive and address requests from entities, whose credentials have been verified, to define access codes that will allow accessing the entity's credentials by others.

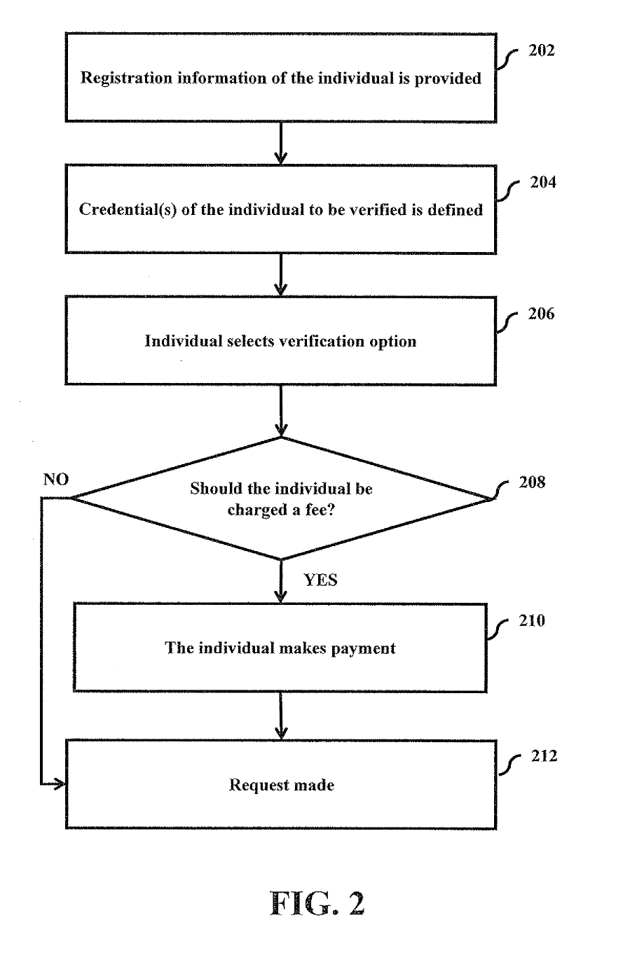

As recited above, request resolution module 102 is configured to receive and address requests from entities to verify their credentials. FIG. 2 is a flow chart illustrating a method of receiving request from an entity to verify his/its credentials, in accordance with an embodiment. At step 202, registration information of the entity is provided. In an embodiment, the entity accesses a website that is dedicated to facilitate verification of credentials. In such a case, the entity provides registration information, such as, for example, the entity's name, address, email address, telephone number, age, gender, and social security number. In another embodiment, the entity may use a website that already has the required registration information to request verification of credentials. For example, the entity (such as, a person) may use a job searching website (third party website), in which the entity is already registered, to send a request for verifying his credentials. It may be noted that, there can be instances in which, information collected from a website, such as a job searching website, may be insufficient. In such a scenario, the missing information is collected from the entity.

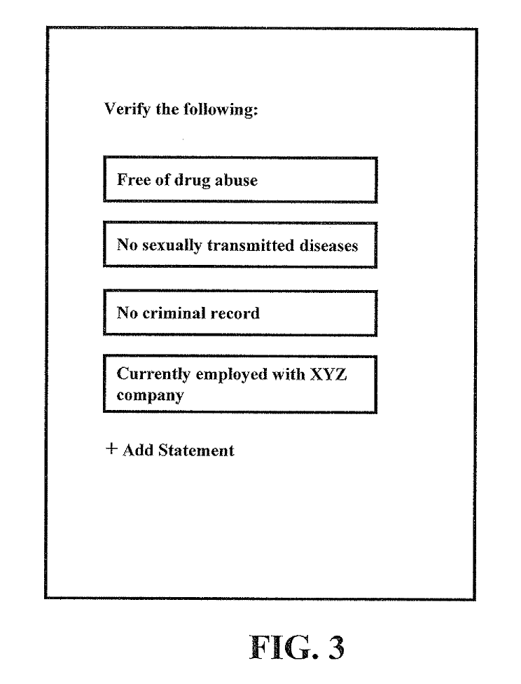

In addition to receiving registration information, at step 204, information corresponding to the credentials of the entity to be verified is received. In an embodiment, the entity may define the credential to be verified as, non-medical drug usage by the entity. In another embodiment, in addition to the above credential or exclusively, the entity (such as, a person) may define the credential to be verified as, sexually transmitted disease status of the entity. In yet another embodiment, the entity can specify statements, which the entity wishes to be verified. FIG. 3 illustrates a user interface, in which the entity defines statements, which he wishes to be verified, in accordance with an embodiment. The entity may define the statements to be verified. Alternatively, the entity may select one or more statements from a list of options that are provided. Further, in a scenario wherein the entity selects from a list of options, the entity can be provided with an option to manually enter some of the fields of the statements, such as, “name of the company”, when the statement corresponds to employment.

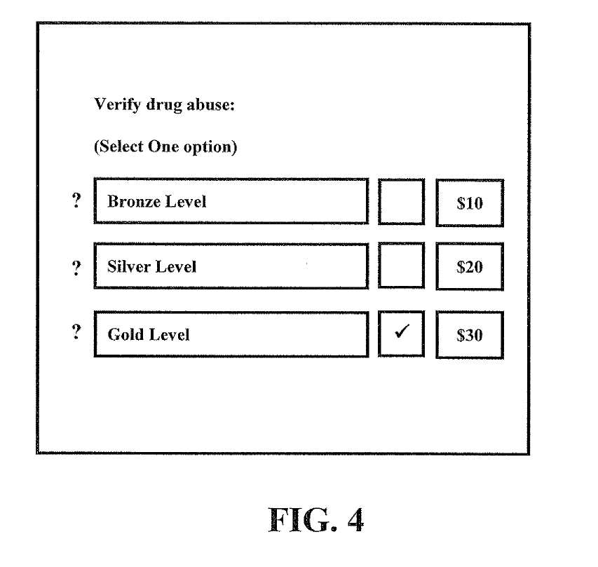

In an embodiment, in addition to defining the credential to be verified, at step 206, the entity selects a verification option. FIG. 4 illustrates a user interface, which provides the entity with verification options, in accordance with an embodiment. Each verification option may have different fee being charged to the entity. Further, more expensive the option, more stringent may be the verification procedure. Hence, the credibility of result of the verification may be directly proportional to the fee for the option being chosen. Further, the entity may be presented with more information about the option upon activating a link (Ex: the character ✓ may be linked to the webpage that provides additional information about the option).

Further, at step 210, fee is collected if the request made by the entity has associated fee, else, the entity's request is accepted without collecting any fee.

It shall be noted that, based on the request being made by the entity, appropriate permissions may be sought from the entity to facilitate verification of credentials. The entity who registers for verification may be referred to as “registered user”.

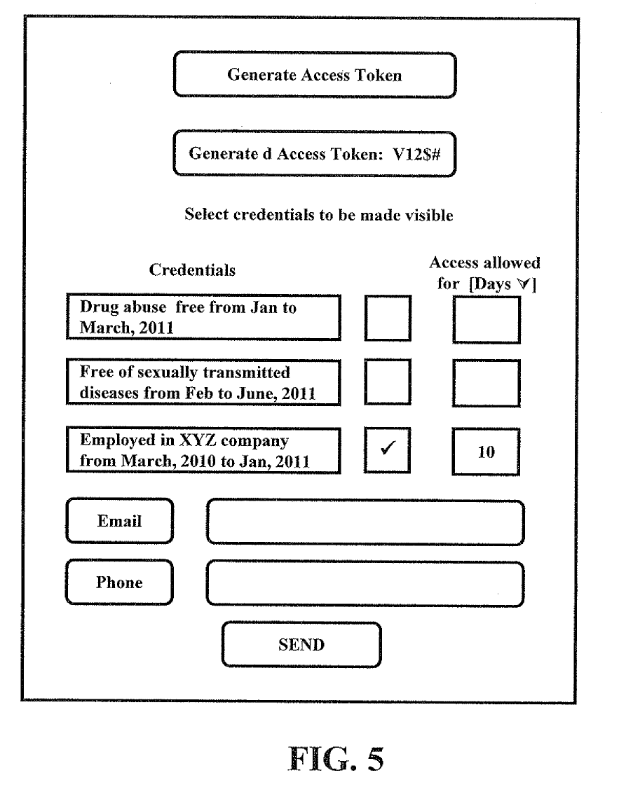

The verification result of the registered user may be accessed by individuals upon being granted permission. The request resolution module 102 can also be configured to receive and address requests to access verified credentials of registered users. In an embodiment, the registered user accesses a website that facilitates generation of access codes, which can be used by individuals to access the result of his credential verification. FIG. 5 illustrates a user interface, wherein the registered user initiates generation of access code, in accordance with an embodiment. The registered user may click on “generate access token” button, which results in generation of access token. In another embodiment, the registered user can define the access token. Further, the user can select the credentials, to which he wants to provide access. The registered user can also define duration (Ex: hours, days, weeks, months or range of dates) during which the credentials remain accessible with the generated/defined access code. Furthermore, the registered user can provide email address or phone numbers of individuals to whom the access code will be sent. The individuals who receive the access code can use the code to access the verification results of the registered user.

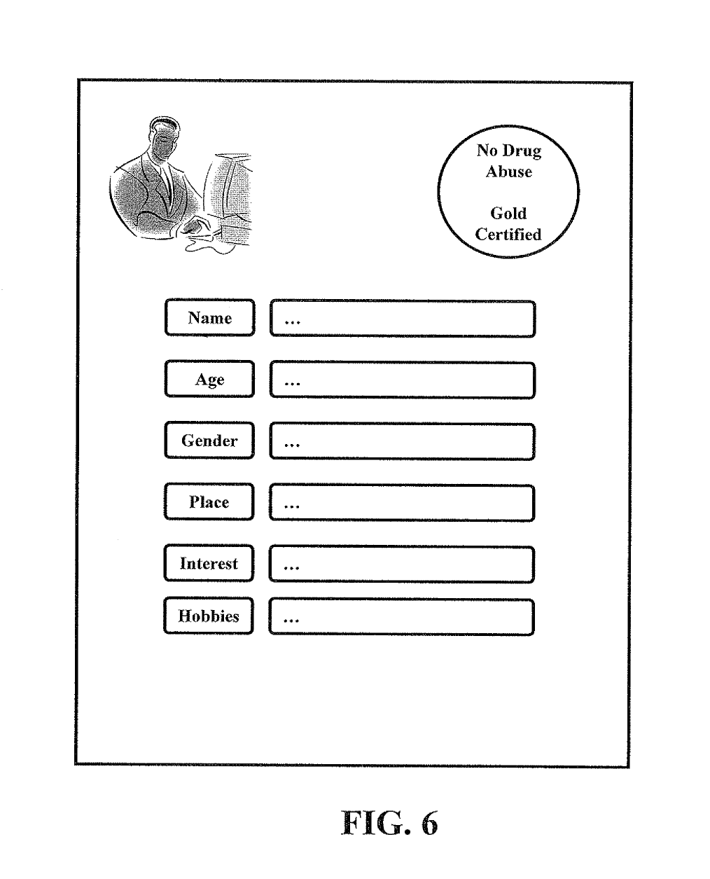

In another embodiment, registered user (such as, a person) may have posted a credential verification badge on his online social profile, such as an online dating website (third party website). It shall be noted that a registered user may possess multiple verification badges, such as, badges corresponding to drug abuse status, criminal record and sexually transmitted diseases, among other badges. FIG. 6 illustrates an online profile of a registered user (such as, a person), in accordance with an embodiment. The registered user may have posted the badge, if the online dating website allows posting of such badges. An individual who visits the profile may click on the badge to access the details of the badge (result of verification). In an embodiment, upon clicking on the badge, a message may be sent to the registered user, informing him that request to access his verification details is being made. The message may also include information about the individual making the request. The registered user, after receiving the message, may decline permission or provide access. In an embodiment, the registered user can define the extent of access granted by using the methodology (at least in part) as discussed earlier.

In another embodiment, the registered user may set criteria to provide automatic access to individuals (requesting access), whose profiles satisfy predefined criteria.

Request resolution module 102, in addition to receiving requests from individuals to access registered users' verification results, is also configured to receive request from registered users to share the result of their verified credentials.

In an embodiment, the registered user accesses a webpage associated with system 100 to request publicly share result of verification. The registered user may select one or more verified credentials to be shared/published on a website (Ex: Online social networking website). The result (or badge associated with the result) may be published if the website allows such publication.

In another embodiment, the registered user may access a website in which he wishes to have the result (or badge associated with the result) published, and initiate publication of the result from that website.

The result of verification is saved in the verification result database 106. The verification result database 106 may be accessed by request resolution module 102, or other applications (with appropriate permission) to address various requests. The verification result database 106 may also be configured to store various criteria's set by the registered user.

The verification module 104 is configured to communicate with the request resolution module 102 and verification result database 106 to enable verification of credentials and sharing of verified credentials.

In an embodiment, verification module 104 is configured to define the methodology for verifying the credentials. The methodology may be determined based of the credentials/statements the registered user wishes to be verified. Further, the methodology may be determined based on the verification option chosen by the registered user.

The verification module 104 may also be configured to inform the user about the verification methodology (verification/testing procedure) at appropriate time. The verification module 104 may also be configured to inform the user about the location (may also include options) at which the registered user has to get himself tested (in case medial testing is required for verification) to facilitate verification.

In an embodiment, the location of testing is determined based on the location of the registered user. The location of the registered user may be determined by collecting data corresponding to the communication device associated with the registered user. Alternatively or additionally, the location of the registered user may be determined based on the IP address from which the registered user has accessed the internet.

In an embodiment, verification module 104 may be configured to collect verification/rating information from multiple sources to provide result of verification/rating. For example, vendors can rate users who are registered with the system 100, when the registered users make purchases from the vendors. The ratings provided by multiple vendors corresponding to a registered user, is used to verify credentials of the registered user or rate the registered user. Based on the verification/rating, vendors can determine how the registered user may be treated during future interactions.

The system and processes being discussed can be applied in various industries. Below provided are examples of some of the applications of the system and processes.

### Example 1

The system 100 and the processes can be used by individuals to verify whether they are involved in drug abuse.

An individual initiates the verification process by accessing a website associated with the system 100. The individual provides information, such as, name, gender, age and location to subscribe to the verification service. Thereafter, the individual is provided with verification options, such as, bronze level, silver level and gold level, each being more expensive than the previous option. The bronze option facilitates urine testing to detect drug abuse, while silver option facilitates urine and hair testing to detect drug abuse. Similarly, gold option facilitates urine and hair testing to detect drug abuse, but with higher frequency of testing as compared to silver option. The individual can select any one of the options and make appropriate payment.

For the sake of explanation, it may be considered that the individual selects gold option. The system 100, based on the instructions that are coded, decides the type of testing and the time at which each of the testing has to be carried out. System 100 informs the individual about the test to be carried out, the location at which the test has to be carried out and the time of test, well before (before a predefined time period) the time of test. After the test is carried out, the test results are sent to the system 100, which in turn certifies the individual accordingly.

If the individual misses the test, then an alternate arrangement for testing may be initiated by the system 100.

Further, the system 100 facilitates sharing of the certification (Ex: in the form of a badge) publicly. The individual can share the badge, for example on his profile page in an online dating website. A badge that indicate that the individual is free of drug abuse when tested using “gold” methodology, increases the individuals chances of finding a suitable date.

If a prospective date is interested in knowing more about the result of testing, the prospective date can click on the badge to request access. The individual can provide access to the prospective date by initiating generation of an access code and sharing the same with the prospective date.

### Example 2

The system 100 and the processes can be used by individuals to verify statements made by them regarding their professional experience.

An individual initiates the verification process through a job searching website, wherein he makes statements, such as, “worked for XYZ company between 2009 to 2010” and “worked for ABC company between 2010 to 2011”. The individual information, such as, name, gender, age and location is sent to the system 100. Thereafter, the individual is provided with verification options, such as, manual verification and semi-automated verification, latter being more expensive and more fool proof than the previous option. The individual can select any one of the options and make appropriate payment. Verification is carried out based on the option selected.

Further, the system 100 indicates verification of the statement being made in the job searching website.

If a prospective employer is interested in knowing more about the result of verification, the prospective employer can click on the indication of verification to request access. The individual can provide access to the prospective employer by initiating generation of an access code and sharing the same with the prospective employer.

The processes described above and illustrated in the drawings is shown as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. A system for enabling, verification of one or more credentials of entities and sharing result of verification, wherein the system is configured to:
receive request from an entity to verify a credential;
verify the credential of the entity according to a predefined methodology; and
allow the entity to share at least a part of result of verification.

2. The system according to claim 1, wherein the request from the entity is received through a third party website.

3. The system according to claim 1, wherein the request from the entity is received through a webpage associated with system.

4. The system according to claim 1, wherein the credential to be verified corresponds to non-medical drug usage by the entity.

5. The system according to claim 1, wherein the credential to be verified corresponds to sexually transmitted disease status of the entity.

6. The system according to claim 1, wherein the credential to be verified corresponds to statements made by the entity.

7. The system according to claim 1, wherein the credential is verified by informing the entity about location and time at which one or more test will be carried out on the entity, before a predefined time period.

8. The system according to claim 7, wherein the system is configured to initiate alternate arrangement for testing if the entity fails to attend the previously informed test.

9. The system according to claim 7, wherein the location for testing is determined based on the location of the entity.

10. The system according to claim 9, wherein the location of the entity is determined based on the location of a communication device associated with the individual.

11. The system according to claim 9, wherein the location of the entity is determined based on the internet protocol address of a data processing device from which the entity accesses the internet.

12. The system according to claim 1, wherein allowing the entity to share at least a part of result of verification comprises, allowing the entity to publish an indication of verification on one or more third party websites.

13. The system according to claim 1, wherein the indication is a badge.

14. The system according to claim 1, wherein allowing the entity to share at least a part of result of verification comprises, enabling generation of access code using which, result of verification can be accessed.

15. The system according to claim 14, wherein expiry period for the access code is configured to be defined.

16. The system according to claim 1, wherein allowing the entity to share at least a part of result of verification comprises, allowing the entity to define the extent to which the result is made visible to others.

17. The system according to claim 1, wherein the system is further configured to allow the entity to select one or more verification options.

18. The system according to claim 17, wherein each verification option at least has a verification methodology that is distinct from the other verification options.

19. A method for enabling, verification of one or more credentials of entities and sharing result of verification, the method comprising:
receiving request from an entity to verify a credential;
verifying the credential of the entity according to a predefined methodology; and
allowing the entity to share at least a part of result of verification.

20. The method according to claim 19, wherein the request from the entity is received through a third party website.

21. The method according to claim 19, wherein the request from the entity is received through a webpage associated with system.

22. The method according to claim 19, wherein the credential is verified by informing the entity about location and time at which one or more test will be carried out on the entity, before a predefined time period.

23. The method according to claim 22, wherein alternate arrangement for testing is initiated, if the entity fails to attend the previously informed test.

24. The method according to claim 22, wherein the location for testing is determined based on the location of the entity.

25. The method according to claim 24, wherein the location of the entity is determined based on the location of a communication device associated with the entity.

26. The method according to claim 24, wherein the location of the entity is determined based on the internet protocol address of a data processing device from which the entity accesses the interne.

27. The method according to claim 19, wherein allowing the entity to share at least a part of result of verification comprises, allowing the entity to publish an indication of verification on one or more third party websites.

28. The method according to claim 19, wherein allowing the entity to share at least a part of result of verification comprises, enabling generation of access code using which, result of verification can be accessed.

29. The method according to claim 29, wherein expiry period for the access code is configured to be defined.

30. The method according to claim 19, wherein allowing the entity to share at least a part of result of verification comprises, allowing the entity to define the extent to which the result is made visible to others.

31. The method according to claim 19, further comprising, allowing the entity to select one or more verification options.
